(19) United States
(12) Patent Application Publication
(10) Pub. No.: US 2023/0080492 A1
(43) Pub. Date: Mar. 16, 2023

(54) OPERATOR WORKPLACE FOR A CONSTRUCTION MACHINE, AND CONSTRUCTION MACHINE

(71) Applicant: BOMAG GMBH, Boppard (DE)

(72) Inventors: Thorsten ANHEIER, Boppard (DE); Thomas KLEIN, Boppard (DE); Thomas HAUBRICH, Boppard (DE)

(21) Appl. No.: 17/930,445

(22) Filed: Sep. 8, 2022

(30) Foreign Application Priority Data
Sep. 15, 2021 (DE) 10 2021 123 916.8

(51) Int. Cl. B62D 33/06; B60N 2/75; B62D 1/04; B60N 2/38

(52) U.S. Cl. CPC B62D 33/0617; B60N 2/79; B62D 1/04; B60N 2/38

(57) ABSTRACT

An operator workplace for a construction machine, comprising a driver seat with a seating surface, an armrest arranged next to the seating surface and having an arm support surface and a control wheel for controlling at least one machine function, the control wheel being rotatable about a control axis, the control axis of the control wheel being tilted relative to a vertical line by a tilt angle in a direction toward the arm support surface of the armrest. Moreover, the invention relates to a construction machine, in particular a ground compaction machine, for example a road roller or single-drum roller, or a road paver, having such an operator workplace.

### FIELD

The invention relates to an operator workplace for a construction machine. Moreover, the invention relates to a construction machine, in particular a ground compaction machine, for example a road roller or single-drum roller, or a road paver, having such an operator workplace.

### BACKGROUND

Generic ground compaction machines are used, for example, in road and pathway construction well as in the construction of public squares or take-off and landing runways. They are, in particular, ground compaction machines such as road rollers, articulated or pivot-steered tandem rollers, rubber-tired rollers or single-drum rollers. Such construction machines are used for compacting grounds or road surfaces, for example asphalt layers. They comprise one or more roller drums and/or wheels with which they are guided over an underlying ground, thereby compacting the latter essentially using their own weight. In addition, roller drums may be set into vibration or oscillation, for example, in a known manner to improve the compaction effect. Moreover, generic construction machines also include, for example, road pavers that are used to spread a paving material, such as asphalt, across an underlying ground with a specified layer thickness and to compact it at least partially.

All these generic construction machines have in common that they need to be controlled particularly precisely during working operation, for example, in order to work as accurately as possible along edges of layers to be compacted or laid. In order to be able to maintain a most comfortable and ergonomic operating posture possible for the driver or operator even when controlling the construction machine as precisely as possible over a longer period of time, they have correspondingly designed operator workplaces. These typically comprise a driver seat with a seating surface on which the driver sits during operation of the construction machine, and an armrest with an arm support surface arranged adjacent to the seating surface. The arm support surface is configured to support an arm, in particular a forearm, of the driver in a sitting posture. It will be appreciated that such arm support surfaces may be provided on both sides of the seating surface. Moreover, it is known to arrange operating elements for various machine functions of the construction machine on the armrests. These may be arranged on the armrest such that the operator can comfortably operate them with the arm resting on the arm support surface. A generic operator workplace of this type is known, for example, from applicant's DE 10 2010 013 041 A1, in which the operating elements comprise, for example, a control lever in the form of a joystick. It is also known to provide the armrest with a control wheel for controlling at least one machine function. The control wheel may, for example, be configured to rotate about a control axis and may in particular act as a steering wheel. Such operator workplaces, in which the armrest has a control wheel, are used, for example, in applicant's pivot-steered BW 154 and BW 174 tandem rollers. These systems already allow very precise and comparatively comfortable control of the machines.

In known operator workplaces, however, the control wheels arranged on the armrest are oriented such that their wheel plane or plane of rotation is either arranged horizontally or tilted forward away from the seating surface and toward the center of the seat. The wheel plane or plane of rotation in this case designates the plane in which the circular path lies which is described by a point on the control wheel while the control wheel is rotated about the control axis. The control axis, in turn, is a virtual axis perpendicular to the wheel plane and passing through the center of the circular path. In the prior art, this wheel plane is either parallel to a horizontal plane, the horizontal plane in this case designating a plane parallel to a planar contact surface of the construction machine. In this arrangement, the control axis is parallel to a vertical line perpendicular to the horizontal plane. Or the wheel plane is inclined away from the armrest's arm support surface—and thus also away from the driver sitting on the driver seat—i.e., inclined forward. In addition, the wheel plane may also be inclined perpendicularly in a direction toward the center of the seat. This arrangement of the wheel plane was chosen to follow, as far as possible, the relaxed position of the driver's arm resting on the arm support surface and his wrist. However, it has now been shown that this arrangement of the control wheel may be uncomfortable for the driver, especially during rotational movements of the control wheel, since the resting position of the wrist is not optimal for the repetitive steering movements on the control wheel. In addition, it has been shown that the corresponding inclination of the control wheel may be partially unintuitive for the driver, who may therefore err in the necessary steering direction, which may lead to incorrect operation of the construction machine.

### SUMMARY

It is therefore the object of the present invention to provide an operator workplace for a construction machine and a construction machine having such an operator workplace providing improved or facilitated control. In particular, the ergonomics for the driver are to be improved and operating errors are to be reduced.

The object is achieved with an operator workplace and a construction machine according to the independent claims. Preferred embodiments are cited in the dependent claims.

Specifically, for a generic operator workplace for a construction machine mentioned above, the object is achieved by tilting the control axis of the control wheel relative to a vertical line by a tilt angle in a direction toward the arm support surface of the armrest. The vertical line designates a direction perpendicular to the horizontal plane already explained above. In particular, the section of the control axis of the control wheel lying vertically above the control wheel or above the wheel plane is tilted toward the arm support surface of the armrest. The arm support surface of the armrest is located in particular at the rear end of the armrest in the region of a backrest, while the control wheel is located in particular at the front end of the armrest. The arm support surface thus also designates the region of the armrest on which the arm, in particular the forearm, of the operator sitting in the driver seat actually rests when the control wheel is operated. For a driver sitting on the driver seat, the control axis of the control wheel is tilted upward in vertical direction, so that the wheel plane is tilted backward, i.e., toward the driver. Direction indications such as “rear”, “front” and “lateral/side” refer in this case to the perception of a driver sitting on the seat or on the seating surface with his gaze directed straight ahead. The direction indications are therefore also independent of an ability of the driver seat to rotate or swivel on the operator platform. When the driver seat moves accordingly, the driver sitting on the seat also moves as a reference point, so that the direction indications still apply in such cases. In the prior art, the wheel plane is tilted forward away from the arm support surface. In contrast to this, the invention now takes the opposite approach, since, according to the invention, the wheel plane is inclined backward, in particular toward the arm support surface. The tilt angle between the control axis and the vertical line according to the invention is also present between the wheel plane and the horizontal plane. The arrangement of the control wheel according to the invention achieves, on the one hand, an ergonomic posture of the arm and also of the wrist of the driver when operating the control wheel. For example, a movement angle to be performed by the wrist for the steering movement is smaller. In this manner, the driver can work at the operator workplace according to the invention in a relaxed manner for extended periods without any negative impact on his health. At the same time, the position of the control wheel according to the invention is much more similar to that of a steering wheel of a passenger car. The use of the control wheel is therefore particularly intuitive, which reduces operating errors by the driver. When the position and/or the orientation of the control wheel and/or the wheel plane and/or the control axis are described herein, this refers to an active working position of the control wheel. This means that the control wheel is actually ready for operation in the position and/or orientation described and can be used to receive or generate control commands. For example, it may be possible that the control wheel, possibly also with parts of the armrest, can be pivoted from the working position to a stowed position, for example to facilitate the movement of an operator in the driver cab. The present invention explicitly does not refer to such a position in which the control wheel is not ready for operation.

The at least one machine function controlled via the control wheel may, for example, be the steering of the construction machine. In addition, however, the control wheel may also be used, at least in part, for other machine functions. For example, the control wheel might be assigned another machine function by a control device of the construction machine, for example its on-board computer, such as control of a working device of the construction machine. In addition, the control wheel might also be used, for example, to adjust parameters of various machine functions, wherein, for example, a rotation in one direction represents an increase and a rotation in the other direction represents a decrease of the respective parameter. Generally, any desired machine functions may be assigned to the control wheel.

The tilt angle according to the invention, i.e., the angle between the control axis and the vertical line or between the wheel plane and a horizontal plane, is preferably between 20° and 70°. Particularly preferably, the angle is between 30° and 60°, especially between 40° and 50°. A specific, preferred embodiment provides for an angle of 45°. The corresponding angle or angle ranges have proven to be particularly ergonomic.

Generally, the control wheel may be arranged on the armrest with a fixed tilt angle. In other words, the control wheel may be arranged on the armrest such that the tilt angle is fixed and remains the same during operation of the operator workplace or the construction machine. According to a preferred embodiment, however, the tilt angle may be adjustable by the driver or operator. In particular, the control wheel is arranged on the armrest in a swiveling manner such that the tilt angle can be freely selected by an operator, especially in a range of 20° to 70° or the angular ranges already mentioned above. In addition, the control wheel can be arrested in various swivel positions, for which purpose a locking device, for example a latching and/or clamping apparatus, is preferably provided. The control wheel can therefore be locked at the armrest in an angular position selected by the operator. In this manner, the operator can select or set a tilt angle that is particularly comfortable for him or advantageous for a specific work situation.

The orientation of the control wheel with the tilt angle according to the invention already leads to significant improvements in ergonomics and intuitive operation. In order to make the operator workplace according to the invention even more flexible, according to a preferred embodiment of the invention, the control wheel is arranged on the armrest inclined relative to the vertical line by an inclination angle oriented perpendicular to the tilt angle, in particular in a range of up to 60°. In particular, the control axis of the control wheel is inclined by the inclination angle relative to the vertical line toward the driver sitting on the seating surface of the driver seat, i.e., toward the center of the seat. Again, the explanations refer to the section of the control axis that lies vertically above the control wheel or the wheel plane. In other words, the control wheel is inclined by the inclination angle in addition to being tilted by the tilt angle, the inclination by the inclination angle being perpendicular to the tilt angle. In particular, the control axis of the control wheel is inclined relative to the vertical line laterally toward the driver or the center of the seat, as seen from the driver's perspective, and accordingly the wheel plane of the control wheel is inclined relative to the horizontal plane laterally toward the driver or the center of the seat. Overall, the control wheel is thus inclined obliquely toward the driver sitting on the seating surface. Such an orientation is particularly intuitive for the driver to operate.

As already explained above for the tilt angle, the inclination angle may likewise be fixed. The control wheel may thus be arranged on the other armrest such that the inclination angle is fixed and remains the same during operation of the operator workplace or the construction machine. According to another preferred embodiment, however, the inclination angle may be adjustable by the driver or operator. For this purpose, the control wheel is arranged on the armrest in a swiveling manner and arrestable in various swivel positions such that the inclination angle can be freely selected by an operator, in particular in a range from 0° to 60°, preferably from 0° to 45°. To lock the control wheel at a desired inclination angle, a locking device, for example a latching and/or clamping apparatus, is again preferably provided. The additional adjustment of the orientation of the control wheel via the inclination angle perpendicular to the tilt angle creates maximum flexibility for the operator. The latter can configure his operator workplace according to his wishes and personal preferences.

In order to provide the operator with the most comfortable position possible when operating the control wheel, it is important that the control wheel is positioned at a comfortable distance from the driver seat. In particular, the control wheel is laterally offset with respect to the seating surface. The control wheel is thus arranged at a distance from the seating surface, in particular in a horizontal plane, transverse to a forward direction or front/rear direction, and/or is not aligned with the seating surface in the front/rear direction. For example, the width of the seat may be used as a reference for the distance. The width of the seating surface is the lateral extension of the seating surface in a horizontal reference plane in the reference to the seated driver already explained above. The width of the seating surface is therefore arranged in particular transversely to a front/rear direction and, for example, perpendicular to the longitudinal extension of the armrest. The width of the seating surface is, for example, 48 cm to 50 cm. In this case, the point of intersection of the wheel plane of the control wheel with the control axis is used as the reference point on the control wheel. Overall, it is preferred that the point of intersection of the wheel plane of the control wheel with the control axis is spaced apart from the seating surface by at least 15%, preferably at least 30% or at least 50%, of the width of the seating surface. A particularly preferred value is 18.5%. Alternatively, the center of the width of the seating surface or the seat index point may be used as a reference for the distance. The seat index point is to be determined in particular according to DIN EN ISO 5353 and is likewise located in the center of the width of the seating surface. The center of the width of the seating surface is in that vertical plane which runs in a front/rear direction and cuts the seating surface in half. The distance of the intersection point from the seating surface, the center of the width of the seating surface or the seat index point is measured in particular parallel to the direction in which the width of the seating surface is determined. In other words, the distance of the intersection point from the seating surface, the center of the width of the seating surface or the seat index point is measured perpendicular to a front/rear direction and perpendicular to the extension of the armrest. In concrete figures, the distance, in particular independent of the respective reference, is for example at least 5 cm, preferably at least 8 cm or at least 12 cm or at least 16 cm or at least 20 cm or at least 25 cm or at least 30 cm. A specific example would be a distance of 8.5 cm to 9.5 cm, for example 9 cm, relative to the seating surface, and 32 cm to 35 cm, for example 33.5 cm, relative to the center of the width of the seating surface or the seat index point. Generally, the armrest may likewise be arranged on the driver seat in a swiveling manner. In particular, the armrest may swivel about a vertical swivel axis at its rear end. By swiveling the armrest accordingly, the distance described above is of course also changed. The respective specifications therefore refer in particular either to a non-swiveling armrest or to a swiveling armrest that is in a central or straight forward-oriented position.

Moreover, for ergonomic operation of the control wheel by the operator, it is important that the control wheel is comfortably accessible while the operator's arm is resting on the arm support surface of the armrest. It is therefore preferred that the point of intersection of the wheel plane of the control wheel with the control axis is arranged in the vertical direction, i.e., along the vertical line essentially at the height of the arm support surface of the armrest. The arm support surface does not need to be shaped parallel to a horizontal plane for this purpose. For example, the arm support surface may also be trough-shaped to support the operator's arm from different sides. The vertical height of the arm support surface is in this case considered to be the position in the vertical direction at which the vertically lowest part of the operator's arm resting on the arm support surface is located. The height of the arm support surface in the vertical direction is therefore the height of the lowest point of the arm support surface in the vertical direction that still comes into contact with the operator's arm when the operator's arm is resting on the arm support surface. This point should be located essentially at the level of the point of intersection of the wheel plane with the control axis. In other words, it is preferred that the point of intersection of the wheel plane of the control wheel with the control axis is arranged in vertical direction in a range of +/−3 cm, preferably +/−2 cm or +/−1 cm around the height of the armrest. A particularly preferred value is 1.3 cm. It is particularly preferred if the intersection point is arranged in vertical direction at the height, that is exactly at the height, of the arm support surface.

For comfortable operation of the control wheel with the arm resting on the arm support surface, it is also important that the control wheel is not too large in diameter. It is therefore preferred that the control wheel has a diameter that essentially corresponds to the width of the arm support surface. The width of the arm support surface is measured parallel to the width of the seating surface. In other words, the width of the arm support surface runs perpendicular to a front/rear direction and, in particular, also perpendicular to a user's arm resting on the arm support surface. It is preferred that the control wheel has a diameter which corresponds, with a maximum deviation of +/−10%, and in particular exactly, to the width of the arm support surface. In concrete figures, the diameter of the control wheel is preferably smaller than 40 cm, particularly preferably smaller than 35 cm or smaller than 30 cm or smaller than 25 cm or smaller than 20 cm or smaller than 15 cm. For example, the diameter is 14 cm.

The armrest of the driver seat extends next to, in particular laterally next to, the seating surface. In particular, it has an arm support region supporting the arm support surface, which forms the rear end of the armrest as viewed from the driver. Moreover, it has, in particular, a mounting region supporting the control wheel, which forms the front end of the armrest as viewed from the driver. Finally, the armrest also comprises a console region connecting the arm support region to the mounting region and located between the other two regions. Of all three regions, the console region has in particular the smallest upward extension in vertical direction, so that the three regions form in particular a U-shape in a side view. For this purpose, it is now preferred that the mounting region extends obliquely away from the arm support surface and/or the console region, i.e., forward, and vertically upward. It is further preferred that the mounting region, especially where the control wheel is mounted, is arranged parallel to the wheel plane of the control wheel. Very preferably, a free space is formed in the mounting region at the vertical height of the console region of the armrest. In other words, a free space is arranged in vertical direction below the mounting region, providing increased leg space for the operator also to the sides in front of the seating surface.

Further freedom of movement for the driver, in particular leg space, is achieved by a side recess. In a preferred embodiment, the armrest thus has a side recess in which the armrest between the arm support surface and the control wheel recedes in the horizontal plane in a direction away from the seating surface, i.e., outward. The side recess itself therefore faces the center of the seat and thus the driver sitting on the seat. The side recess is located in the console region and/or in the mounting region of the armrest. Preferably, the side recess extends in the front/rear direction along the armrest at least to the control wheel. Similarly, transverse to the front/rear direction, the side recess preferably extends to the control wheel and in particular to the point of intersection of the wheel plane of the control wheel with the control axis. In particular, the side recess extends in a direction away from the arm support surface, i.e., forward, to beyond a front edge of the seating surface. The front edge of the seating surface designates in particular the front end of the seating surface. In particular, the front edge of the seating surface designates the end closest to the knees of an operator sitting on the driver seat. Seen from above, the outer contour of the armrest thus recedes laterally in the region of the side recess and extends forward in receded position.

According to a preferred embodiment, the control wheel has an operating aid which in particular makes it easier to grip the control wheel. For this purpose, the control wheel may, for example, have a handle knob, which is in particular arranged on the control wheel in a rotatable manner. In particular, the handle knob is rotatably mounted relative to the control wheel such that it can be grasped by an operator and used to turn the control wheel without having to change the grip on the handle knob. Additionally or alternatively, a recess, in particular a crescent-shaped recess, may also be provided on the control wheel, in particular a recess on the outer circumferential surface of the control wheel. Said outer circumferential surface represents the part of the control wheel radially furthest away from the control axis. The recess may, for example, be a trough or a groove. In this case, the outer circumference of the control wheel is therefore not a closed circle all the way around, but has a transitional inward offset due to the recess. During operation, an operator can place one or more fingers in the recess, making it easier to operate the control wheel.

In order to be able to control further machine functions via the armrest, it is preferred that an operating console with at least one operating element for controlling at least one machine function is arranged on the armrest between the control wheel and the arm support surface. The operating console is arranged in particular in the console region of the armrest. The machine function to be controlled may be the same or a different machine function, which may likewise be controllable via the control wheel. The further operating elements of the operating console may be, for example, switches, knobs, sliders or the like. In particular, they are arranged in vertical direction below the arm support surface and thus also below the point of intersection of the control axis and the wheel plane. In this manner, they are spaced apart from the operator's arm resting on the arm support surface and there is no risk of accidentally operating the operating elements.

The object mentioned at the beginning is also achieved with a construction machine, in particular a ground compaction machine, for example a road roller or a single-drum roller, or a road paver, with an operator workplace according to the preceding explanations. All explanations of features, advantages and effects made with respect to the operator workplace according to the invention apply mutatis mutandis also to the construction machine according to the invention, and vice versa. Merely to avoid repetitions, reference is made to the respective other explanations.

### BRIEF DESCRIPTION OF THE DRAWINGS

The invention will be explained in more detail below by reference to the embodiment examples shown in the figures. In the schematic figures:

FIG. 1 is a side view of a tandem roller;

FIG. 2 is a side view of a single-drum roller;

FIG. 3 is a side view of a road paver;

FIG. 4 is a side view of an operator workplace;

FIG. 5 is a top view of an operator workplace;

FIG. 6 is a side view of an armrest; and

FIG. 7 is a perspective view of an armrest.

### DETAILED DESCRIPTION

Like parts, or parts acting in a like manner, are designated by like reference numerals. Recurring parts are not designated separately in each figure.

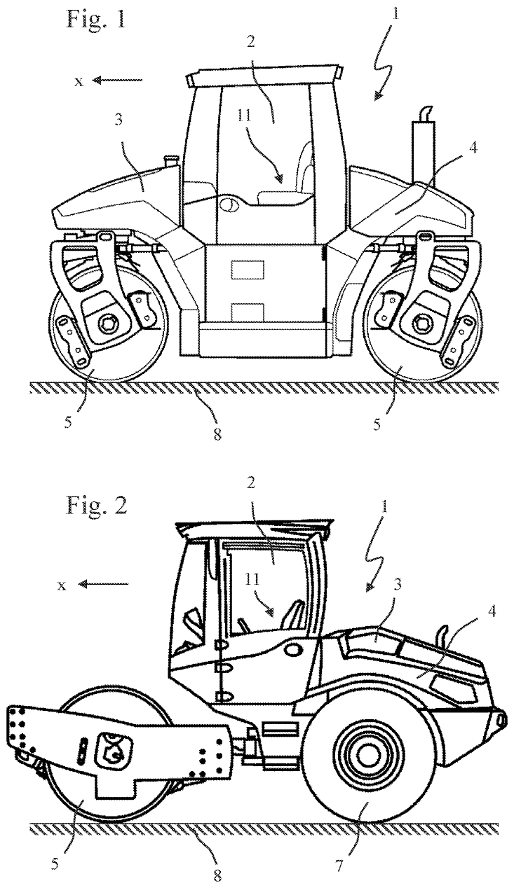

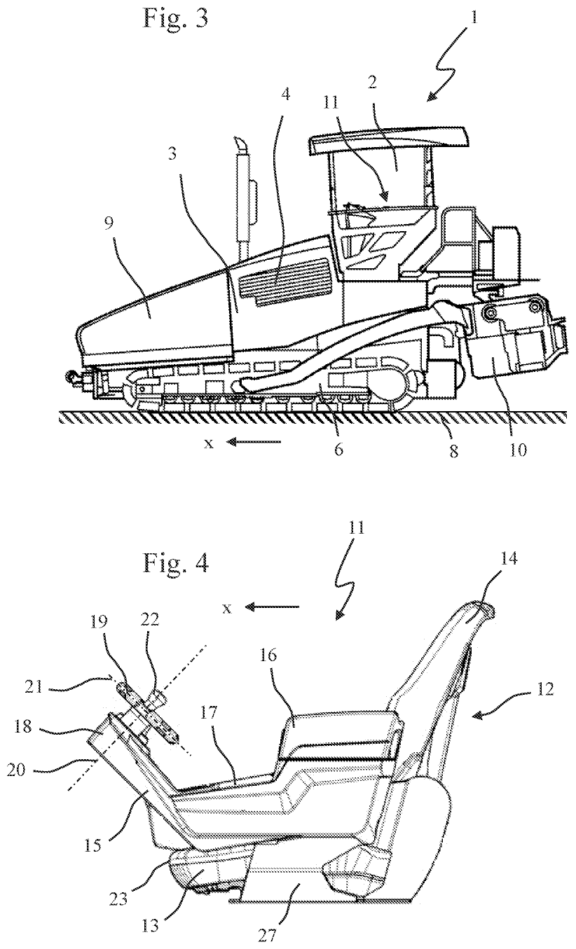

FIGS. 1 to 3 show various examples of generic construction machines 1. In particular, FIG. 1 shows a pivot-steered tandem roller, FIG. 2 shows a single-drum roller, and FIG. 3 shows a road paver. However, the invention is not limited to the three types of construction machines 1 shown, but may also be applied to other types of construction machines 1. The construction machines 1 comprise, for example, an operator platform 2, which is supported in particular by a machine frame 3. The machine frame 3 is in turn preferably supported by a travel mechanism which, for example in the case of the tandem roller according to FIG. 1, may comprise two roller drums 5. The travel mechanism of the single-drum roller according to FIG. 2 in turn preferably comprises a front roller drum 5 and rear wheels 7, while the travel mechanism of the road paver according to FIG. 3 preferably comprises a crawler track mechanism 6. In addition, the construction machines 1 preferably have a drive motor 4, which may be, for example, an internal combustion engine, in particular a diesel engine, or an electric motor. The construction machines 1 are thus preferably self-propelled and move using their own drive unit. With their travel mechanism, the construction machines 1 move, for example, in or against the working direction x over the ground 8, which is compacted by the roller drums 5 or on which a paving layer is laid by the road paver. For this purpose, the roller drums 5 may also be set into vibration in a known manner. For paving a layer, the road paver preferably has a material hopper 9 as shown in FIG. 3 in a known manner, from which the material to be paved, e.g. asphalt, is transported backward through the road paver to a paving screed 10. The paving material is then distributed transversely to the working direction x and is pre-compacted via the paving screed 10.

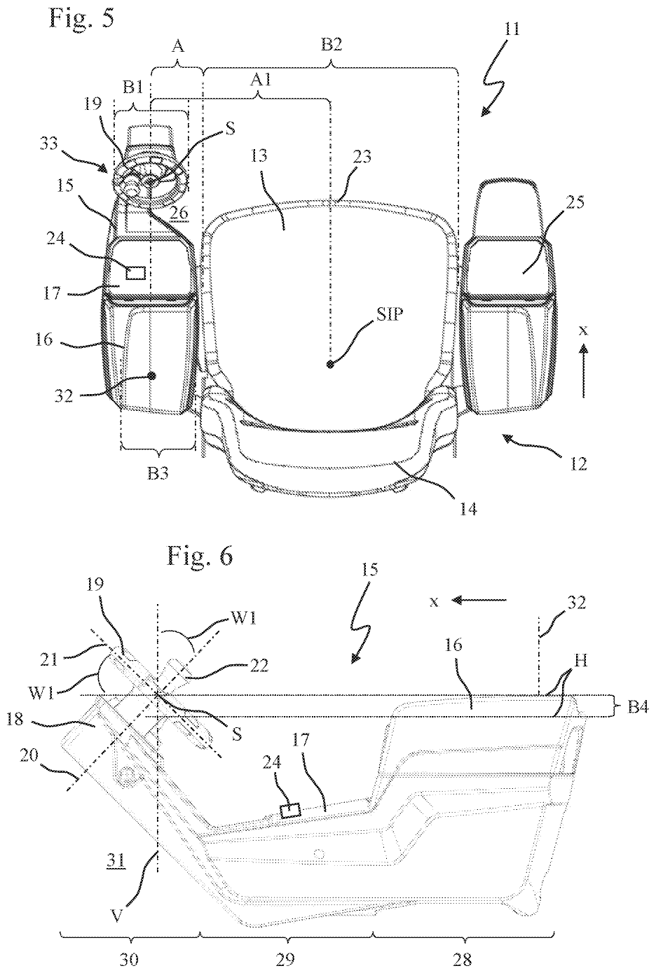

On the operator platform 2, the construction machines 1 preferably each have an operator workplace 11, which is shown in a side view in FIG. 4 and in a top view in FIG. 5. There may be more than one operator workplace 1 provided. The operator workplace 11 preferably comprises a driver seat 12, which in turn comprises a seating surface 13, optionally a backrest 14, and an armrest 15. The armrest 15 is, for example, attached to the driver seat 12 or a substructure of the driver seat 12 via a mounting bracket 27. The armrest 15 may be height-adjustable in a vertical direction by means of a mechanism that is not shown. Additionally or alternatively, the armrest 15 may swivel about a vertical swivel axis 32. The armrest 15 supports a control wheel 19, as will be discussed in more detail below. As can be seen from the top view in FIG. 5, the driver seat 12 preferably also comprises a further armrest 25, on which various operating elements may be arranged as well. The armrest 25 may be mirrored but identical to the armrest 15, or may differ from the armrest 15. Via the control wheel 19 on the armrest 15, an operator sitting on the driver seat 12 and in particular the seating surface 13 can control a machine function. For example, the operator may steer the construction machine 1 using the control wheel 19 as if using a conventional steering wheel. To facilitate operation of the control wheel 19, the latter preferably comprises an operating aid, for example in the form of a handle knob 22 rotatably mounted on the control wheel 19. Additionally or alternatively, the control wheel 19 may also have a recess 33, which is arranged in particular on the outer surface of the control wheel 19, and which may be engaged by an operator.

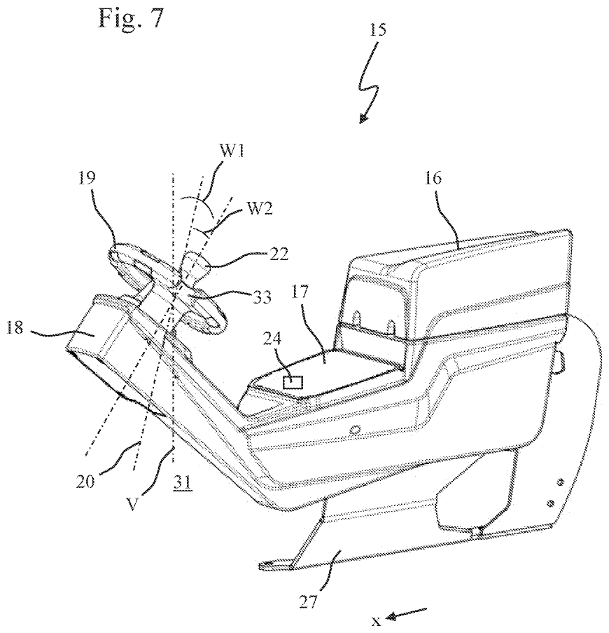

A specific exemplary structure of the armrest 15 is best seen in the detail views of FIGS. 6 and 7. For purposes of the present description, it is assumed that the driver seat 12 is oriented straight ahead in the working direction x, so that the working direction x also corresponds to a front/rear direction for a driver sitting on the driver seat 12. If the driver seat 12 is rotatable about a vertical axis, the reference direction x will rotate with it. The armrest 15 therefore preferably extends in the front/rear direction or in the working direction x next to the seating surface 13 of the driver seat 12. Any reference in this description to “front”, “rear” and “lateral” likewise refers to this direction, with “lateral” referring to a direction transverse to the front/rear direction. As shown in FIG. 6, the armrest 15 may, for example, have three different regions, more specifically an arm support region 28 located at the rear, a console region 29 following toward the front, and a mounting region 30 closing off the armrest 15 toward the front. In the arm support region 28, the armrest 15 has an arm support surface 16 that is configured such that an operator sitting on the seating surface 13 can rest his arm, in particular his forearm, on it in a comfortable sitting posture. For this purpose, the arm support surface 16 preferably comprises a padding which is partially rounded, in particular in cross-section, in order to provide a safeguard against lateral slipping of an arm resting on the arm support surface 16. In particular, the arm support surface 16 may be slid forward or backward on the armrest 15, depending on the operator's preference. In the console region 29, in turn, the armrest 15 preferably has an operating console 17 on which at least one operating element 24, such as a switch, a slider or a knob, is preferably arranged. The operator can preferably use this operating element 24 to control further machine functions.

The front end of the armrest 15 is preferably formed by the mounting region 30. It is advantageous in this case if the arm support region 28 and the mounting region 30 protrude beyond the console region 29 in vertical direction, so that the armrest 15 has an overall U-shaped configuration as viewed from the side. The mounting region 30 preferably comprises a control wheel support 18 on which the control wheel 19 is rotatably mounted. The control wheel 19 has a wheel plane 21 (FIGS. 4 and 6) corresponding to the plane of rotation of the control wheel 19, and in particular a control axis 20 corresponding to the rotation axis of the control wheel 19. As shown in particular in FIG. 6, according to the invention, the control axis 20 is inclined by a tilt angle W1 with respect to the vertical line V, namely in a direction toward the arm support surface 16, when the course of the control axis 20 is viewed vertically upward. In other words, the control axis 20 is tilted backward by the tilt angle W1 with respect to the vertical line V. The same tilt angle W1 is also found between the wheel plane 21 and a horizontal plane H. In the embodiment example shown, the tilt angle W1 is approximately 45°, but may also assume other values. As a result, the plane of rotation thus runs in a plane x ascending in the forward direction. By arranging the control wheel 19 such that the control wheel 19 is tilted backward toward the operator, the operator can control the control wheel 19 in an intuitive, ergonomic manner with an arm resting on the arm support surface 16, and can do so for extended periods of time without fatigue or adverse health effects. The tilt angle W1 may be either fixed or freely selectable or adjustable by the operator.

FIG. 5 shows that the seating surface 13 may have a width B2. The width B2 of the seating surface 13 is measured in particular transverse to the front/rear direction. The seat index point SIP of the driver seat 12 is located at the center of the width B2 of the seating surface 13. It is to be determined according to DIN EN ISO 5353. The intersection point S between the wheel plane 21 and the control axis 20 is located at the center of the control wheel 19. The distance A between the intersection point S and the seating surface 13, which is also shown, is preferably likewise measured transverse to the front/rear direction. The distance A is preferably at least 15% of the width B2 of the seating surface 13. The distance A1 between the intersection point S and the center of the width B2 of the seating surface 13 or the seat index point SIP is also preferably measured transverse to the front/rear direction. The distance A1 is preferably at least 30 cm. The diameter B1 of the control wheel 19 in turn preferably corresponds essentially to the width B3 of the arm support surface 16. This width B3 is likewise measured in particular transverse to the front/rear direction. All of this ensures that the operator can comfortably reach and use the control wheel 19 with the arm resting on the arm support surface 10.

This is further facilitated by the arrangement of the control wheel 19 in the vertical direction, i.e. along the vertical line V. This is shown in FIG. 6. The height of the arm support surface 16 in the vertical direction is shown in FIG. 6 by the lower of the two horizontal planes H shown. The height of the arm support surface 16 in the vertical direction designates in particular the vertical height of the lowest point of an operator's arm resting on the arm support surface 16. The upper of the two shown horizontal planes H, on the other hand, runs through the intersection point S between the wheel plane 21 and the control axis 20. The vertical distance B4 between the arm support surface 16 and the intersection point S is preferably in the range of a few centimeters. This likewise ensures ergonomic handling of the control wheel 19 by the operator.

FIG. 5 also shows a measure that ensures the greatest possible freedom of movement for the operator, for example leg space. Specifically, a side recess 26 may be provided on the armrest 15, particularly in the mounting 30. The side recess 26 is preferably located on the inner side of the armrest 15 facing the seating surface 13, so that it recedes at this point and provides additional space for the operator. The side recess 26 is configured such that it extends transverse to the front/rear direction to the point of intersection S of the control axis 20 with the wheel plane 21. In the front/rear direction, the side recess 26 preferably extends beyond a front edge 23 of the seating surface 13. The front edge 23 designates the forward end of the seating surface 13. The side recess 26 preferably completely penetrates the armrest 15 in the vertical direction, so that the armrest 15 is open both in downward and upward direction. In this manner, the side recess 26 cooperates advantageously with a free space 31, which is shown, for example, in FIG. 6, and which is created in particular by the control wheel support 18, i.e., the section of the armrest 15 in the mounting region 30, extending obliquely forward and upward. In this manner, the free space 31 is preferably created in vertical direction below the control wheel support 18, which likewise increases the leg space of the operator. It is now particularly preferred that the side recess 26 and the free space 31 form a continuous free space. In other words, the side recess 26 and the free space 31 merge into each other without forming any obstructions, thus providing an overall free space that can be used by the operator, for example, during certain leg movements and is perceived as comfortable.

As shown in FIG. 7, in addition to the inclination of the control wheel 19 by the tilt angle W1, a further inclination by the inclination angle W2 may also be provided. The inclination angle W2 is arranged perpendicular to the tilt angle W1 and designates an inclination of the control wheel 19 or the wheel plane 21 and the control axis 20 in a direction toward the seating surface 13. The inclination angle W2 may likewise be either fixed or freely selectable or adjustable by the operator.

Overall, the invention enables intuitive, ergonomic operation of the control wheel 19, which can be operated for extended periods without causing health consequences for the driver.

What is claimed is:

1-14. (canceled)

15. An operator workplace for a construction machine, comprising:
a driver seat with a seating surface;
an armrest arranged next to the seating surface and having an arm support surface and a control wheel to control at least one machine function, the control wheel being rotatable about a control axis, and
wherein the control axis of the control wheel is tilted relative to a vertical line by a tilt angle in a direction toward the arm support surface of the armrest.

16. The operator workplace according to claim 15, wherein the tilt angle is in a range from 20° to 70°.

17. The operator workplace according to claim 16, wherein the tilt angle is in the range from 30° to 60°.

18. The operator workplace according to claim 15, wherein the control wheel is arranged on the armrest in a swiveling manner and arrestable in various swivel positions such that the tilt angle is selectable by an operator in a range of the tilt angle, wherein the tilt angle is in a range from 20° to 70°.

19. The operator workplace according to claim 15, wherein the control wheel is arranged on the armrest inclined relative to the vertical line by an inclination angle oriented perpendicular to the tilt angle, wherein the inclination angle is in a range of up to 60°.

20. The operator workplace according to claim 15, wherein the control wheel is arranged on the armrest in a swiveling manner and arrestable in various swivel positions such that the inclination angle is selectable by an operator, wherein the inclination angle is in a range from 0° to 60°.

21. The operator workplace according to claim 20, wherein the inclination angle is in the range from 0° to 45°.

22. The operator workplace according to claim 15, wherein the control wheel is arranged at a distance from the seating surface in a horizontal plane and transverse to a front/rear direction.

23. The operator workplace according to claim 15, wherein a point of intersection of a wheel plane of the control wheel with the control axis is spaced apart by at least 15% of a width of the seating surface from the seating surface.

24. The operator workplace according to claim 23, wherein the point of intersection of the wheel plane of the control wheel with the control axis is spaced apart by at least 30% of the width of the seating surface from the seating surface.

25. The operator workplace according to claim 15, wherein a point of intersection of a wheel plane of the control wheel with the control axis is spaced apart by at least 20 cm from a center of a width of the seating surface or a seat index point (SIP) of the driver seat.

26. The operator workplace according to claim 15, wherein a point of intersection of a wheel plane of the control wheel with the control axis is arranged in a vertical direction in a range of +/−3 cm of a height of the arm support surface.

27. The operator workplace according to claim 15, wherein the control wheel has a diameter which corresponds, with a maximum deviation of +/−10%, to a width of the arm support surface.

28. The operator workplace according to claim 15, wherein the armrest comprises an arm support region supporting the arm support surface, a mounting region supporting the control wheel, and a console region connecting the arm support region to the mounting region, the mounting region extending obliquely away from the arm support surface and vertically upward.

29. The operator workplace according to claim 28, wherein the mounting region is arranged parallel to a wheel plane of the control wheel.

30. The operator workplace according to claim 15, wherein the armrest has a side recess in which the armrest recedes between the arm support surface and the control wheel in the horizontal plane in a direction away from the seating surface, the side recess extending in a direction away from the arm support surface.

31. The operator workplace according to claim 30, wherein the side recess extends in the direction away from the arm support surface beyond a front edge of the seating surface.

32. The operator workplace according to claim 15, wherein the control wheel has an operating aid in a form of a handle knob arranged rotatably on the control wheel, and/or a recess arranged on the control wheel.

33. The operator workplace according to claim 15, wherein an operating console with at least one operating element to control at least one machine function is arranged on the armrest between the control wheel and the arm support surface.

34. The operator workplace according to claim 15, wherein the operator workplace is disposed on a construction machine.
